(19) United States
(12) Patent Application Publication
(10) Pub. No.: US 2009/0073213 A1
(43) Pub. Date: Mar. 19, 2009

(54) Image forming apparatus

(75) Inventor: Atsuki Iwata, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/232,151

(22) Filed: Sep. 11, 2008

(30) Foreign Application Priority Data
Sep. 18, 2007 (JP) 2007-241355

(51) Int. Cl. B41J 29/38; B41J 2/01

(52) U.S. Cl. 347/19; 347/104; 347/9; 347/16

(57) ABSTRACT

A printer includes a line-type inkjet printer, sheet feed trays, and a sheet receiving tray. The line-type inkjet printer includes a conveying unit that conveys a transfer sheet in a nearly vertical direction and an inkjet unit that discharges ink on an entire area in a width direction of the transfer sheet that is conveyed by the conveying unit from a direction perpendicular to the transfer sheet and forms an image on the transfer sheet. The line-type inkjet printer further includes a maintenance mechanism that maintains the inkjet unit and a controller that controls maintenance of the inkjet unit.

### CROSS-REFERENCE TO RELATED APPLICATIONS

The present application claims priority to and incorporates by reference the entire contents of Japanese priority document 2007-241355 filed in Japan on Sep. 18, 2007.

### BACKGROUND OF THE INVENTION

1. Field of the Invention

The present invention relates to an image forming apparatus that includes a line-type inkjet printer.

2. Description of the Related Art

A line-type inkjet printer, which forms an image on a transfer sheet by simultaneously discharging ink on an entire area of the transfer sheet in a width direction, is well known. Such a line-type inkjet printer is used in an image forming apparatus, such as a printer, along with a sheet feed tray that houses blank transfer sheets, a sheet feeding unit that supplies a blank transfer sheet from the sheet feed tray to the line-type inkjet printer, a sheet discharging unit that discharges an image-printed transfer sheet from the line-type inkjet printer, and a sheet receiving tray that collects the image-printed transfer sheets discharged by the sheet discharging unit. Line-type inkjet printers are fast and cost effective.

Japanese Patent Application Laid-open No. 2004-9404 discloses arranging the line-type inkjet printer and the sheet receiving tray horizontally in the image forming apparatus.

Image forming apparatuses are known in which the line-type inkjet printer, the sheet feed tray, and the sheet receiving tray are vertically stacked, moreover, the blank transfer sheets in the sheet feed tray, the image-printed transfer sheets in the sheet receiving tray, and the transfer sheets that are undergoing printing process are horizontal.

Image forming apparatuses are know that include, in addition to the line-type inkjet printer, an ink-head maintenance mechanism that cleans an ink-head of the line-type inkjet printer, discharges unnecessary ink, and maintains the ink-head; an ink-head retreating mechanism that retreats the ink-head from a printing position to a maintenance position; and a controller that controls a retreating operation of the ink-head.

Japanese Patent Application Laid-open No. H6-171181 discloses a compact and slim printer.

However, the arrangement disclosed in Japanese Patent Application Laid-open No. 2004-9404 leads to a significant increase in the size and cost of the image forming apparatus.

Image forming apparatuses that employ vertical stack arrangement may be compact, however, they require a sheet discharging roller for discharging image-printed transfer sheets in the sheet receiving tray. Because image forming is carried out at high-speed, the sheet discharging roller becomes soiled due to half dried ink on the transfer sheet and the transfer sheet is spoiled by the soiled sheet discharging roller.

The image forming apparatus that includes the ink-head maintenance mechanism, the ink-head retreating mechanism, and the controller along with the line-type inkjet printer is bulky and costly. Furthermore, because an execution liming of the retreating operation becomes complicated, the load on the controller also increases.

The printer disclosed in Japanese Patent Application Laid-open No. H6-171181 may be compact and slim, however, it does not employ a line-type inkjet printer. A concrete structure that enhances the compactness and slimness when a line-type inkjet is used has not been disclosed. Specifically, it is not known whether this printer includes the maintenance mechanism, the retreating mechanism, and the controller. In the printer disclosed in the technology mentioned earlier, a structure for arranging a plurality of sheet feed trays is not included and a problem that causes the sheet discharging roller to become soiled is also not taken into consideration.

### SUMMARY OF THE INVENTION

It is an object of the present invention to at least partially solve the problems in the conventional technology.

According to an aspect of the present invention, there is provided an image forming apparatus including a line-type inkjet printer that includes a conveying unit that conveys a transfer sheet in a nearly vertical direction; and a line-type inkjet unit that discharges, from a direction perpendicular to the transfer sheet, ink on an entire area in a width direction of the transfer sheet that is being conveyed by the conveying unit to print an image on the transfer sheet thereby producing an image-printed transfer sheet. The image forming apparatus further includes a sheet feed tray that houses blank transfer sheets; a sheet feeding unit that feeds a blank transfer sheets from the sheet feed tray to the conveying unit; a sheet discharging unit that discharges the image-printed transfer sheet; and a sheet receiving tray that receives the image-printed transfer sheet discharged by the sheet discharging unit. The sheet feed tray houses the blank transfer sheets substantially horizontally and the sheet feed tray is arranged at a position that is substantially vertically below the inkjet unit, the sheet receiving tray houses the image-printed transfer sheets substantially horizontally and the sheet receiving tray is arranged at a position that is substantially vertically above the inkjet unit, and the sheet discharging unit guides the image-printed transfer sheet to the sheet receiving tray by aligning a non-image forming surface of the image-printed transfer sheet with the sheet discharging unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an overview of a line-type inkjet printer and an image forming apparatus according to a first embodiment of the present invention;

FIG. 2 is a perspective view of a transfer sheet conveying unit shown in FIG. 1;

FIG. 3 is a schematic diagram for explaining horizontal movement of an inkjet unit with respect to the transfer sheet conveying unit and a maintenance mechanism;

FIG. 4 is a schematic diagram for explaining rotation of the inkjet unit with respect to the transfer sheet conveying unit and the maintenance mechanism;

FIG. 5 is a detailed functional block diagram of a controller shown in FIG. 1;

FIG. 6 is a flowchart for explaining operations performed by the controller according to the first embodiment; and

FIG. 7 is a flowchart for explaining operations performed by a controller according to a second embodiment of the present invention.

### DETAILED DESCRIPTION OF THE PREFERRED EMBODIMENTS

Exemplary embodiments of present invention are explained in detail below with reference to the accompanying drawings. The present invention is not limited to those embodiments. Various modifications may be made without departing from the spirit or scope of the present invention.

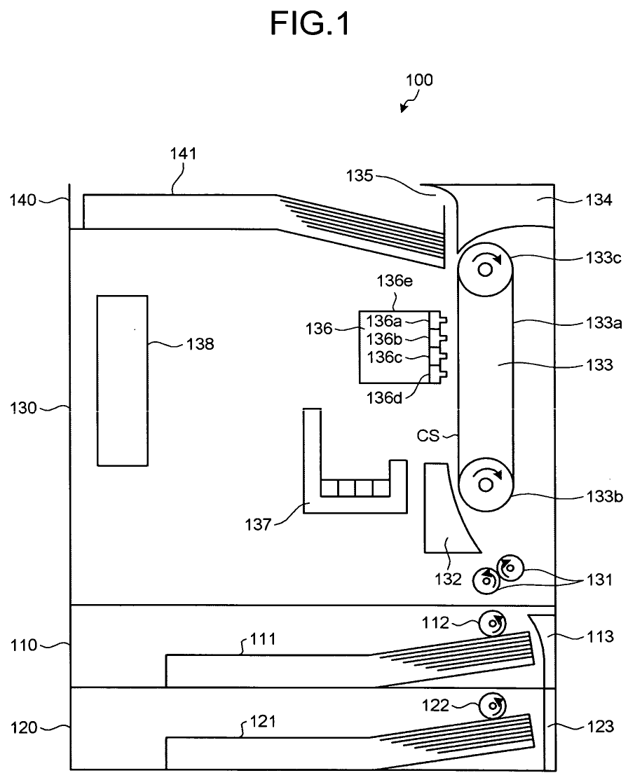

An image forming apparatus according to a first embodiment of the present invention is explained with reference to FIGS. 1 to 6. The image forming apparatus is a printer; however, the image forming apparatus 100 can be a device other than a printer.

FIG. 1 is a schematic diagram for explaining an overview of the printer 100. The printer 100 includes a first sheet-feed tray 110, a second sheet-feed tray 120 that is arranged below the first sheet-feed tray 110, a main body unit 130 that includes a line-type inkjet printer that is described later and that is arranged above the first sheet-feed tray 110, and a sheet receiving tray 140 that is arranged above the main body unit 130.

The first sheet-feed tray 110 contains blank transfer sheets 111. The second sheet-feed tray 120 contains different type, size, or orientation of blank transfer sheets 121. An image-printed transfer sheet, which can be a transfer sheet picked from the first sheet-feed tray 110 or the second sheet-feed tray 120, is discharged in the sheet receiving tray 140 after printing an image thereon as an image-printed transfer sheet.

The first sheet-feed tray 110 includes a pickup roller 112 and a guide plate 113 on a transfer sheet discharging side. The first sheet-feed tray 110 houses the transfer sheet 111 such that the transfer sheet 111 substantially horizontal. To be specific, the first sheet-feed tray 110 houses a plurality of transfer sheets 111 such that the transfer sheets 111 are adjusted with respect to each other. In the first sheet-feed tray 110, a portion of the transfer sheet 111 is pushed in a nearly vertical upward direction by a (not shown) spring that is arranged at the bottom on the transfer sheet discharging side. The pickup roller 112 is arranged above the transfer sheet 111 on the transfer sheet discharging side. By pushing the portion of the transfer sheet 111 in the nearly vertical upward direction, a surface of the transfer sheet 111 contacts the pickup roller 112. The transfer sheet 111 that contacts the pickup roller 112 is transmitted to the guide plate 113 by a rotational force of the pickup roller 112. The transmitted transfer sheet 111 is supplied to the main body unit 130 that is arranged above the first sheet-feed tray 110 along the guide plate 113. When one transfer sheet 111 is supplied to the main body unit 130, the next transfer sheet 111 contacts the pickup roller 112. Thus, the transfer sheets 111 in the first sheet-feed tray 110 are one by one supplied to the main body unit 130.

The structure applied for supplying a transfer sheets to the main body unit 130 is not limited to the above-explained structure. Any structure can be applied in which the transfer sheets 111 can be one by one retrieved from at least the first sheet-feed tray 110 and can be supplied to the main body unit 130.

The second sheet-feed tray 120 includes a pickup roller 122 and a guide plate 123 on the transfer sheet discharging side. The second sheet-feed tray 120 functions similarly as the first sheet-feed tray 110. Therefore, its explanation is omitted.

Whether to operate any one of the first sheet-feed tray 110 and the second sheet-feed tray 120, in other words, whether to supply any one of the transfer sheet 111 and the transfer sheet 121 to the main body unit 130 is suitably decided according to a size of a transfer sheet that is to be printed and a number of remaining transfer sheets.

Without limiting to the first sheet-feed tray 110 and the second sheet-feed tray 120, one, or more than or equal to three sheet feed trays can be included. If a plurality of sheet feed trays is included, a frequency of replenishing transfer sheets into the sheet feed tray reduces. The transfer sheet of a different size can be collected in the respective sheet feed tray. Thus, usability of a printer enhances.

The main body unit 130 includes sheet feed rollers 131 that are arranged above the first sheet-feed tray 110 on the transfer sheet discharging side, a conveyance guide plate 132 that is arranged in a vicinity of the sheet feed rollers 131, a conveying unit 133, an inkjet unit 136, a maintenance mechanism 137, a controller 138, and a sheet-discharge guide plate 134 that is arranged above the conveying unit 133. To be specific, the line-type inkjet printer is formed of the conveying unit 133, the inkjet unit 136, the maintenance mechanism 137, and the controller 138.

The sheet feed rollers 131 guide the transfer sheet 111 or 121 supplied from the first sheet-feed tray 110 or the second sheet-feed tray 120 to the conveyance guide plate 132. The sheet feed rollers 131 include a pair of rollers having substantially parallel shafts. The sheet feed rollers 131 contact or move proximally towards each other such that the transfer sheet is sandwiched between the sheet feed rollers 131. The guide plate 113 of the first sheet-feed tray 110 guides the transfer sheet 111 or 121 supplied from the first sheet-feed tray 110 or the second sheet-feed tray 120 to between the sheet feed rollers 131. The sheet feed rollers 131 that are arranged in an opposite direction from each other, rotate in a direction in which the transfer sheet can be supplied from the guide plate 113 to the conveyance guide plate 132. The transfer sheet guided to between the sheet feed rollers 131 is then guided to the conveyance guide plate 132 by the rotational force of the sheet feed rollers 131.

The transfer sheet, which is guided to the conveyance guide plate 132, is guided to the conveying unit 133 along the shape of the conveyance guide plate 132. The transfer sheet that has reached the conveying unit 133 is conveyed to the sheet-discharge guide plate 134 while undergoing through an image forming process. The transfer sheet that has reached the sheet-discharge guide plate 134 is transmitted along the shape of the sheet-discharge guide plate 134 such that the transfer sheet gradually becomes horizontal and the transfer sheet is discharged to the sheet receiving tray 140. To be specific, during a transmission period of the transfer sheet, only the back surface on which the image is not formed contacts the sheet-discharge guide plate 134. In other words, an image forming surface of the image-printed transfer sheet does not contact any member.

In the sheet receiving tray 140 that is arranged above the main body unit 130, a sheet discharge opening 135 is formed by a wall portion of the sheet receiving tray 140 and the sheet-discharge guide plate 134. The transfer sheet 141 that is discharged along the sheet-discharge guide plate 134 is stacked in the nearly horizontal position in the sheet receiving tray 140. A bottom of the sheet receiving tray 140 on the sheet discharge opening 135 side is progressively becoming deeper towards the sheet discharge opening 135. In other words, the bottom face of the sheet receiving tray 140 on the sheet discharge opening 135 side inclines downward towards the sheet discharge opening 135. Due to this, the transfer sheet 141, which is discharged from the sheet discharge opening 135, is stacked in the sheet receiving tray 140 such that one side of the transfer sheet 141 contacts the wall of the sheet receiving tray 140 on the sheet discharge opening 135 side. Thus, the transfer sheets 141 are arranged in the sheet receiving tray 140. According to the present embodiment, the sheet receiving tray 140 is arranged on the topmost surface of the printer 100. Due to this, users of the printer 100 can easily collect the transfer sheets 141 stacked in the sheet receiving tray 140.

Thus, in the printer 100, while discharging the image-printed transfer sheet, any member does not directly contact the image forming surface of the transfer sheet. In other words, none of the members is soiled due to half dried ink, thus not spoiling the transfer sheet.

The line-type inkjet printer is explained in detail below. As mentioned earlier, the line-type inkjet printer includes the conveying unit 133, the inkjet unit 136, the maintenance mechanism 137, and the controller 138. The conveying unit 133 conveys in the nearly vertical upward direction, the transfer sheet 111 or 121 that is supplied along the conveyance guide plate 132 from the first sheet-feed tray 110 or the second sheet-feed tray 120. The inkjet unit 136 is arranged near the conveying unit 133 such that the inkjet unit 136 can move horizontally and rotatingly. The ink is discharged on the entire area in the width direction of the transfer sheet in a direction perpendicular to a surface of the transfer sheet and the image is formed on the transfer sheet. In the present embodiment, “width” of the transfer sheet is a length of the transfer sheet in a direction orthogonal to a conveyance direction. The maintenance mechanism 137 is arranged in the vicinity of the inkjet unit 136 and is used for maintaining the inkjet unit 136. The controller 138 controls a printing operation, a retreating operation, and a maintenance operation of the inkjet unit 136.

The conveying unit 133 includes an endless conveying belt 133a, a rotatable first conveying-belt roller 133b, and a rotatable second conveying-belt roller 133c. The first conveying-belt roller 133b is a driving roller that drives the conveying belt 133a and the second conveying-belt roller 133c. To be specific, the first conveying-belt roller 133b and the second conveying-belt roller 133c are arranged inside the endless conveying belt 133a. The conveying belt 133a is stretched on the first conveying-belt roller 133b and the second conveying-belt roller 133c. The first conveying-belt roller 133b and the second conveying-belt roller 133c have shafts that are substantially parallel to each other. In this structure, the conveying belt 133a has, between the first conveying-belt roller 133b and the second conveying-belt roller 133c, two nearly plane moving surfaces that are parallel to each other and that inversely move in the vertical direction. Hereinafter, from the two moving surfaces, the surface that is moving in a vertical upward direction is called a conveying surface CS as a surface on which the transfer sheet is conveyed. A width of the conveying belt 133a is greater than the width of the transfer sheet. A direction of “width” is also defined as a direction of the rotating shaft of the first conveying-belt roller 133b or the second conveying-belt roller 133c.

A magnitude relation of the first conveying-belt roller 133b and the second conveying-belt roller 133c is not considered. If the conveying unit 133 can be formed such that the transfer sheet can be conveyed in the nearly vertical upward direction, in addition to the first conveying-belt roller 133b and the second conveying-belt roller 133c, another conveying belt roller can be arranged.

The conveyance guide plate 132 guides the transfer sheet such that the transfer sheet becomes nearly parallel to the conveying surface CS. The guided transfer sheet is adsorbed to the conveying surface CS by an adsorption method that is described later. The adsorbed transfer sheet is conveyed in the nearly vertical upward direction by the conveying belt 133a. During the conveyance of the transfer sheet by the conveying belt 133a, the inkjet unit 136 carries out printing on the transfer sheet. After the image is formed, the transfer sheet is detached from the conveying belt 133a near the second conveying-belt roller 133c and is discharged to the sheet receiving tray 140 along the sheet-discharge guide plate 134.

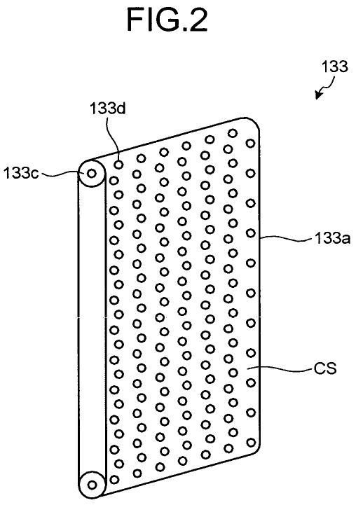

The adsorption method used for the transfer sheet is explained with reference to FIG. 2. FIG. 2 is a schematic diagram of the transfer sheet conveying unit 133. Holes are formed in the transfer sheet conveying belt 133a in a certain pattern.

As shown in FIG. 2, the conveying belt 133a has holes 133d in a certain pattern on the entire surface. When the transfer sheet is adsorbed to the conveying surface CS, air inside the conveying belt 133a is ejected by an (not shown) exhaust fan. Due to this, a negative pressure is formed inside the conveying belt 133a and the transfer sheet can be adsorbed to the conveying belt 133a. By ejecting the air only from the specific area of the conveying surface CS, the transfer sheet can be partially adsorbed to the conveying belt 133a. A container, which is connected to the exhaust fan and that includes one or a plurality of openings, is arranged inside the conveying belt 133a such that the openings are arranged near the specific area. The specific area is assumed as an area outside the vicinity of the second conveying-belt roller 133c. Thus, the transfer sheet can be easily detached from the conveying surface CS near the second conveying-belt roller 133c. By arranging the container, formation of the unnecessary negative pressure can be avoided.

In another adsorption method, by charging the conveying belt 133a by using a high-voltage power supply, the transfer sheet can be electrostatically adsorbed to the conveying surface CS of the conveying belt 133a. By removing the static electricity of the specific area on the conveying surface CS, the electrostatic adsorption of the transfer sheet can be partially weakened. For example, if the static electricity of the conveying surface CS is removed near the second conveying-belt roller 133c, the transfer sheet can be easily detached from the conveying surface CS near the second conveying-belt roller 133c.

The inkjet unit 136 includes ink-heads 136a to 136d that respectively discharges the ink of cyan (C), magenta (M), yellow (Y), and black (K) color and an inkjet main body 136e. Each ink-head 136a to 136d is formed of an ink nozzle row of the length that matches with the width of the transfer sheet. Thus, moving the inkjet unit 136 in the width direction of the transfer sheet is not necessary. Color printing of one line portion can be carried out at the same time. In the present embodiment, the one line indicates one line of the image formed on the transfer sheet. The one line does not indicate a physical line (ink nozzle row) of the respective ink-head 136a to 136b.

It is not always necessary to arrange the ink-heads 136a to 136d that respectively discharges the ink of CMYK color. One ink-head that discharges only black (K) ink can be arranged in a printer that is applied only for black and white printing. Furthermore, ink-heads equivalent to a number of primary colors used in a printer can be arranged in the printer that is applied for expressing colors other than a CMYK method.

Because the transfer sheet is conveyed in the nearly vertical upward direction by the conveying unit 133, the image forming surface also becomes nearly vertical. Thus, the inkjet unit 136 is arranged such that while executing the printing operation, the discharge direction of the ink becomes perpendicular to the image forming surface of the transfer sheet. To be specific, while executing the printing operation, the inkjet unit 136 is arranged such that a direction of each ink nozzle of the ink-heads 136a to 136d becomes nearly horizontal.

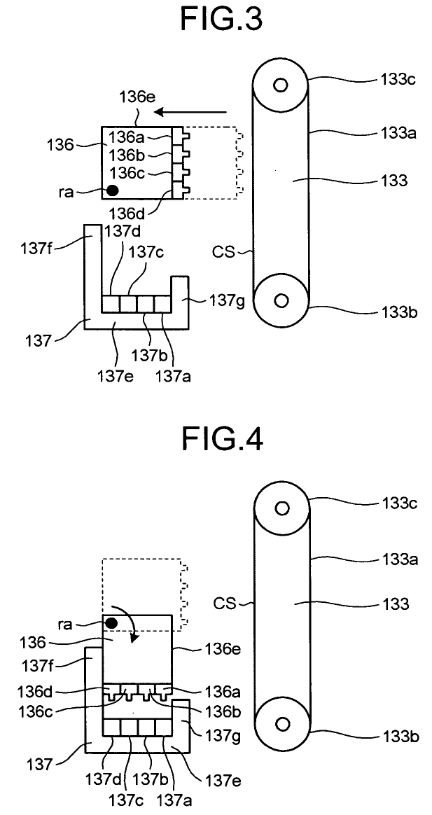

When maintenance such as cleaning the ink-heads 136a to 136b and discharging the unnecessary ink is necessary, the inkjet unit 136 executes the retreating operation. The retreating operation is explained with reference to FIGS. 3 and 4. FIG. 3 is a schematic diagram for explaining horizontal movement of the inkjet unit 136 with respect to the transfer sheet conveying unit 133 and the maintenance mechanism 137. FIG. 4 is a schematic diagram for explaining rotation of the inkjet unit 136 with respect to the transfer sheet conveying unit 133 and the maintenance mechanism 137.

The inkjet unit 136, which is perpendicular to the conveying surface CS, can be moved horizontally in a direction away from the conveying surface CS. The inkjet unit 136 can be rotated with respect to a rotation axis ra that is described later. Because the inkjet unit 136 can be horizontally moved and rotated, the inkjet unit 136 can be moved until the vicinity of the maintenance mechanism 137.

The rotation axis ra of the inkjet unit 136 is nearly parallel to the rotating shafts of the first conveying-belt roller 133b and the second conveying-belt roller 133c. It is desirable to arrange the rotation axis ra at the position where a horizontal moving distance and a rotation distance of the inkjet unit 136 is minimum. For example, the rotation axis ra is arranged at the position that is away from the ink-heads 136a to 136d as compared to the center of the inkjet unit 136. It is more desirable to arrange the rotation axis ra below the inkjet main body 136e in a printing operation position of the inkjet unit 136.

If it is necessary to maintain the ink-heads 136a to 136d, the inkjet unit 136, which is in the direction perpendicular to the conveying surface CS, horizontally moves in the direction away from the conveying surface CS from the printing operation position by a (not shown) horizontal moving mechanism. The moving distance is such that the inkjet unit 136 after rotation can be arranged at a maintenance operation position. By assuming the rotation axis ra as the center, the inkjet unit 136 rotates in 90 degrees in a clockwise direction. Thus, the inkjet unit 136 is arranged at the maintenance operation position.

The maintenance mechanism 137 is arranged at the position that enables to maintain the ink-heads 136a to 136d of the inkjet unit 136 by horizontally moving and rotating the inkjet unit 136. To be more specific, the maintenance mechanism 137 includes maintenance-mechanism ink-head facing units 137a to 137d, a bottom portion 137e, a first sidewall 137f, and a second sidewall 137g that faces the first sidewall 137f and that is shorter than the first sidewall 137f. The maintenance mechanism 137 is arranged in a nearly vertical downward direction of the inkjet unit 136. The size of the maintenance-mechanism ink-head facing units 137a to 137d is the same or larger than the size of the ink-heads 136a to 136d. The maintenance-mechanism ink-head facing units 137a to 137d correspond to the mechanism applied for executing the maintenance operation of the respective ink-head 136a to 136d. The first sidewall 137f is arranged away from the conveying belt 133a as compared to the second sidewall 137g. Wall faces of the first sidewall 137f and the second sidewall 137g are nearly parallel to the conveying surface CS. In other words, a hook-shape is formed by the bottom portion 137e, the first sidewall 137f, and the second sidewall 137g.

Due to rotation of the inkjet unit 136, the inside surface of the first sidewall 137f contacts a side surface of the inkjet unit 136. In other words, the first sidewall 137f functions as a guide plate for regulating the rotation distance of the inkjet unit 136. By functioning as the guide plate, each ink-head 136a to 136d can be arranged opposite the corresponding maintenance mechanism ink-head facing unit 137a to 137d at the appropriate position. Due to this, the maintenance operation such as cleaning the ink-heads 136a to 136d and discharging the unnecessary ink can be reliably carried out.

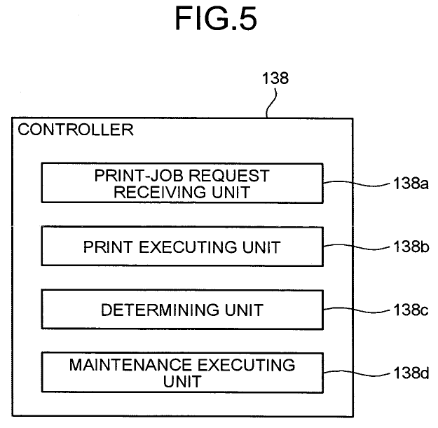

The controller 138 controls the printing operation, the retreating operation, and the maintenance operation executed by the inkjet unit 136. The controller 138 can be arranged at any position that will not interfere with the printing operation and the maintenance operation. FIG. 5 is a block diagram of the controller 138.

As shown in FIG. 5, the controller 138 includes a print-job request receiving unit 138a, a print executing unit 138b, a determining unit 138c, and a maintenance executing unit 138d. The print-job request receiving unit 138a corresponds to a print queue of the printer 100 and stores therein print job requests in an issuing sequence of the print job requests. The print job is a printing data of a single document. The printing data is data of the images (characters are treated as a type of the image) formed on more than or equal to a single transfer sheet. The print jobs are the jobs that are typically issued from an external device such as a computer that is connected to the printer 100 by wire or without wire. However, by arranging a memory slot in the printer 100, the print jobs can be read from a storage medium such as a memory card.

The print executing unit 138b retrieves the print job from the print-job request receiving unit 138a and causes the inkjet unit 136 to execute the print job for each line. Apart from controlling the inkjet unit 136, the print executing unit 138b also controls the conveyance of the transfer sheet by the pickup roller 112, the sheet feed rollers 131, and the conveying unit 133. The determining unit 138c determines whether to execute the maintenance operation. Based on the determination by the determining unit 138c, the maintenance executing unit 138d causes the inkjet unit 136 to execute the retreating operation and a restoring operation that is described later. The maintenance executing unit 138d also causes the inkjet unit 136 and the maintenance mechanism 137 to execute the maintenance operation.

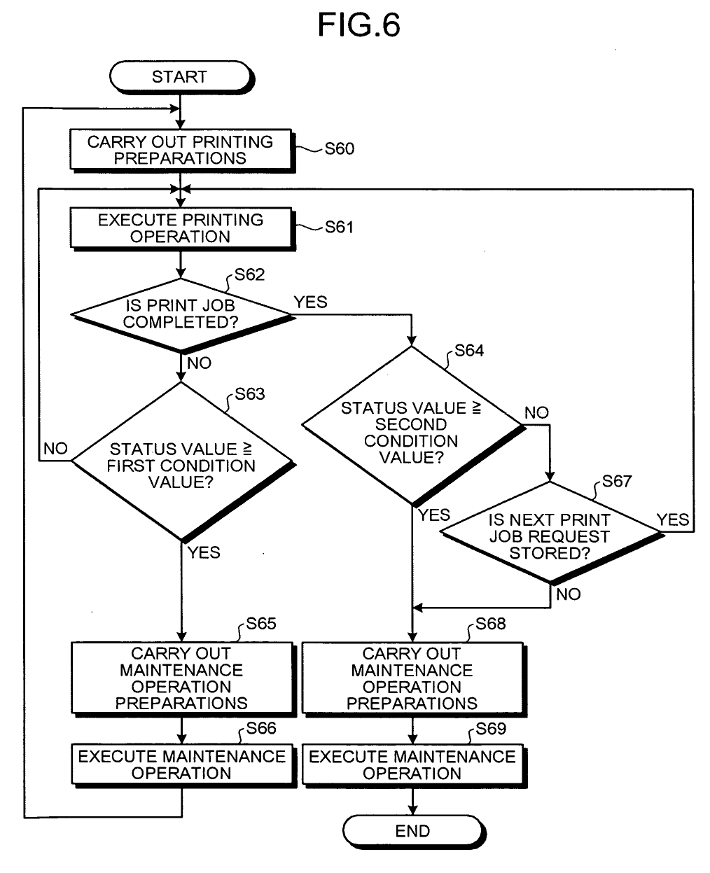

An execution timing of the maintenance operation of the controller 138 is explained below. FIG. 6 is a flowchart for explaining operations performed by the controller 138. A status of the inkjet unit 136 that is arranged at the maintenance operation position is assumed as an initial status.

If the print jobs are stored in the print-job request receiving unit 138a, the print executing unit 138b carries out print preparations. To be specific, the print executing unit 138b executes the restoring operation that causes the inkjet unit 136 to move from the maintenance operation position to the printing operation position. The restoring operation is the reverse operation of the retreating operation and can be accomplished by rotating and horizontally moving the inkjet unit 136 (Step S60).

When the transfer sheet is not conveyed up to a printing start position, the print executing unit 138b controls the pickup roller 112, the sheet feed rollers 131, and the conveying unit 133 and moves the transfer sheet up to the printing start position. If the transfer sheet moves up to the printing start position, the print executing unit 138b causes the inkjet unit 136 to execute the printing operation for the first line of the print job (Step S61).

Upon the print executing unit 138b completing printing of the one line portion, the determining unit 138c determines whether the print job is completed (Step S62). If the print job is not completed (No at Step S62), the determining unit 138c compares a status value that indicates a continuous usage status of the inkjet unit 136 and a prior decided first condition value (Step S63). If the print job is completed (Yes at Step S62), the determining unit 138c compares the status value of the inkjet unit 136 and a prior decided second condition value (Step S64).

The status value indicates a time period required for the printing operation until the present moment after the previous maintenance operation is completed, a time period during which the inkjet unit 136 is arranged at the printing operation position, a total time period during which the inkjet unit 136 is not available at the maintenance operation position, and a number of lines printed till the present moment after the previous maintenance operation is completed. In other words, the status value is a parameter indicating a usage status of the inkjet unit 136. The first condition value and the second condition value indicate threshold values of the status value. For example, when the number of printing lines after the maintenance operation is executed is indicated as the status value, the first condition value and the second condition value indicate the prior decided number of printing lines. The status value is reset after the maintenance operation is executed. The user can decide the first condition value and the second condition value by using the computer connected to the printer 100. Furthermore, the first condition value and the second condition value can be set by directly operating the printer 100 or can be fixed at the time of manufacturing a printer.

Upon comparing the status value and the first condition value, if the status value is less than the first condition value (No at Step S63), the printing operation of a next one line portion in the same print job is executed (Step S61). If the status value is greater than or equal to the first condition value (Yes at Step S63), preparations for the maintenance operation with respect to the ink-heads 136a to 136d are carried out (Step S65). In other words, the maintenance executing unit 138d executes the retreating operation of the inkjet unit 136. Upon completing the retreating operation, the maintenance operation is executed with respect to the ink-heads 136a to 136d (Step S66). Upon completing the maintenance operation, the print executing unit 138b carries out printing preparations for the next one line portion in the same print job that is to be printed (Step S60).

Upon comparing the status value and the second condition value, if the status value is less than the second condition value (No at Step S64), the determining unit 138c determines whether the next print job request is stored in the print-job request receiving unit 138a (Step S67). If the next print job request is stored (Yes at Step S67), the print executing unit 138b causes the inkjet unit 136 to execute the printing operation for the first line of the print job (Step S61). Thus, if the next print job request is issued when the inkjet unit 136 is arranged at the printing operation position, without carrying out new printing preparations, the printing operation is immediately executed. Due to this, deterioration of printing efficiency is avoided.

If the next print job request is not stored in the print-job request receiving unit 138a (No at Step S67), preparations of the maintenance operation to be executed for the ink-heads 136a to 136d are carried out (Step S68). In other words, the maintenance executing unit 138d executes the retreating operation of the inkjet unit 136. Upon completing the retreating operation, the maintenance operation is executed with respect to the ink-heads 136a to 136d (Step S69). Upon completing the maintenance operation, the inkjet unit 136 waits at the maintenance operation position until a new print job request is received by the print-job request receiving unit 138a. During the waiting period, the maintenance operation can be executed at regular intervals.

Upon comparing the status value and the second condition value, if the status value is greater than or equal to the second condition value (Yes at Step S64), the maintenance executing unit 138d carries out preparations of the maintenance operation (Step S68) and executes the maintenance operation (Step S69). Upon completing the maintenance operation, the inkjet unit 136 waits at the maintenance operation position until a new print job request is received by the print-job request receiving unit 138a. During the waiting period, the maintenance operation can be executed at regular intervals.

A reason for setting the two condition values such as the first condition value and the second condition value and a relation between the first condition value and the second condition value is explained below. It is necessary to execute the maintenance operation when the ink nozzles of the ink-heads 136a to 136d are clogged or the dust is adhered to the ink nozzles. The status such as clogging of the ink nozzles or adhesion of the dust onto the ink nozzles cannot be understood without seeing an actual printing result. For example, appearance of thin spots or ink blurring in the print result indicates that cleaning of the ink-heads 136a to 136d is necessary. Generally, to maintain the ink-heads 136a to 136d in a clean state, executing the maintenance operation is necessary when the one line portion is printed.

However, the maintenance operation including the retreating operation requires a certain amount of time period. Thus, if the maintenance operation is frequently executed, the time required for completing a single print job increases. Generally, clogging of the ink nozzles or adhesion of dust occurs if the printing operation is executed for number of times or the ink-heads 136a to 136d are retained at the printing operation position for a long period of time. Thus, executing the maintenance operation for each printing of the one line portion is wasteful. Due to this, a parameter needs to be taken into consideration in which relativity between clogging of the ink nozzles and adhesion of dust is high. Thus, the maintenance operation can be executed more effectively only if conditions including the parameter are fulfilled. The condition indicated by one numeric value is the first condition value. If whether to execute the maintenance operation is determined only based on the first condition value, the printing efficiency is likely to deteriorate. For example, if the parameter fulfils the first condition value immediately after a new print job is started, the inkjet unit 136 moves to the maintenance operation. Thus, even if the total printing volume of the new print job is small, a printing process is discontinued due to the retreating operation and the maintenance operation and the user who is waiting for the printing to complete is subjected to the psychological stress. After completing the single print job, although an insignificant time lag occurs until start of the new print job, the user accepts the time lag as the time required for printing. Thus, the psychological stress is reduced. When the single print job is completed, whether the maintenance operation is required is determined based on the second condition value that is stricter condition than the first condition value. In other words, whether the maintenance operation is required is repeatedly determined during execution of the same print job and is also determined when the print job is completed. However, the maintenance operation execution conditions are different in both determinations.

The execution timing of the maintenance operation is explained by a concrete example. For example, the number of printing lines after the maintenance operation is executed is assumed as the status value. The total number of lines on the transfer sheet upon completing the print job are assumed as 1900, the first condition value is assumed as 1000 lines, and the second condition value is assumed as 800 lines. The number of printing lines, in other words, the status value is reset to zero immediately after the maintenance operation is executed. Upon receiving the print job request, the controller 138 moves the inkjet unit 136 up to the printing operation position and executes the printing operation with respect to a first line on the transfer sheet. If the number of lines printed on the transfer sheet are less than or equal to 999, because the print job is not completed and the status value is also less than the first condition value, the printing operation up to the 999-th line is repeated. If the 1000-th line is printed, the maintenance operation is executed because the status value that is 1000 lines is more than or equal to the first condition value that is 1000 lines. The status value is reset to zero immediately after the maintenance operation is executed. During the printing operation from 1001-st line up to the 1899-th line, because the print job is not completed and the status value is also less than the first condition value, the printing operation is repeated with respect to the lines from 1001 to 1899. If 1900-th line is printed, the print job is completed and the status value that is 900 lines and the second condition value that is 800 lines at the time of completion of the print job are compared. Thus, because the status value is more than or equal to the second condition value, the maintenance operation is executed.

In another example that is explained below, the total number of lines printed on the transfer sheet upon completing the print job are 1700 lines and another conditions are same as the conditions in the example mentioned earlier. Because the print job is completed upon printing the 1700^{th} line, the status value that is 700 lines and the second condition value that is 800 lines at the time of completion of the print job are compared. Because the status value is less than the second condition value, whether the next print job request exists is confirmed. If the next print job request exists, the printing operation is executed and if the next print job request does not exist, the maintenance operation is executed.

In the concrete example specified for the execution timing of the maintenance operation, although the number of printing lines after the maintenance operation is executed is explained as the status value, the continuous usage time of the inkjet unit 136 after the maintenance of the inkjet unit 136 is completed can be used as the status value. Furthermore, an image forming frequency after the maintenance of the inkjet unit 136 is completed can be used as the status value. In other words, any status value can be used if the maintenance operation can be carried out after every predetermined time period or for every predetermined printing line.

According to the present embodiment, the conveying unit 133 conveys the transfer sheet in a nearly vertical direction and when the transfer sheet is being conveyed, the ink is discharged on the transfer sheet from the direction perpendicular to the transfer sheet. Due to this, the image can be formed on the transfer sheet. Thus, the line-type inkjet printer and the image forming apparatus including the line-type inkjet printer can be made compact. Furthermore, by arranging the sheet receiving tray 140 on the topmost surface of the printer 100 and by including a plurality of sheet feed trays, the usability of the image forming apparatus can be enhanced.

By the retreating operation that is carried out by slightly moving and rotating the inkjet unit 136, the ink-heads 136a to 136d can be arranged opposite the maintenance-mechanism ink-head facing units 137a to 137d. Due to this, the line-type inkjet printer and the printer 100 can be made compact. Consequently, the cost can be reduced. Furthermore, a maintenance mechanism can be simplified. By including a controller that considers the maintenance execution timing mentioned earlier, the simple maintenance execution timing can be realized. Thus, the usability of the line-type inkjet printer and the image forming apparatus including the line-type inkjet printer can be enhanced.

In the printer 100, a structure of a direct current (DC) power supply unit and control boards is not concretely explained and is not shown in drawings. The DC power supply unit supplies power to a printer. The control boards are an image data processing board, an engine board, an input output processing board, and a high-voltage power board. The DC power supply unit and the control boards can be arranged at any position in the printer 100. However, it is desirable to arrange the DC power supply unit and the control boards at the position that will not interfere with the maintenance operation and the printing operation.

In the present embodiment, the inkjet unit 136 moves horizontally while executing the retreating operation of the inkjet unit 136. However, the present embodiment is not to be thus limited. Depending on the arrangement of the controller 138, the inkjet unit 136 cannot be moved horizontally. In such a situation, the inkjet unit 136 can be moved in a direction that is not horizontal, for example, in a slanting direction such that the inkjet unit 136 will not contact the controller 138. Due to this, the line-type inkjet printer and the printer 100 can be made compact.

The direction for conveying the transfer sheet need not always be the vertical direction. The printer 100 can be made compact at least in the horizontal width direction by inclining the conveying surface CS in the horizontal direction.

According to the operation of the controller 138, the determining unit 138c determines whether to execute the maintenance operation for each printing operation of the one line portion by the print executing unit 138b. However, the determining unit 138c can also determine whether to execute the maintenance operation for each printing operation for more than or equal to two lines and for the number of lines less than or equal to the lines on the one transfer sheet.

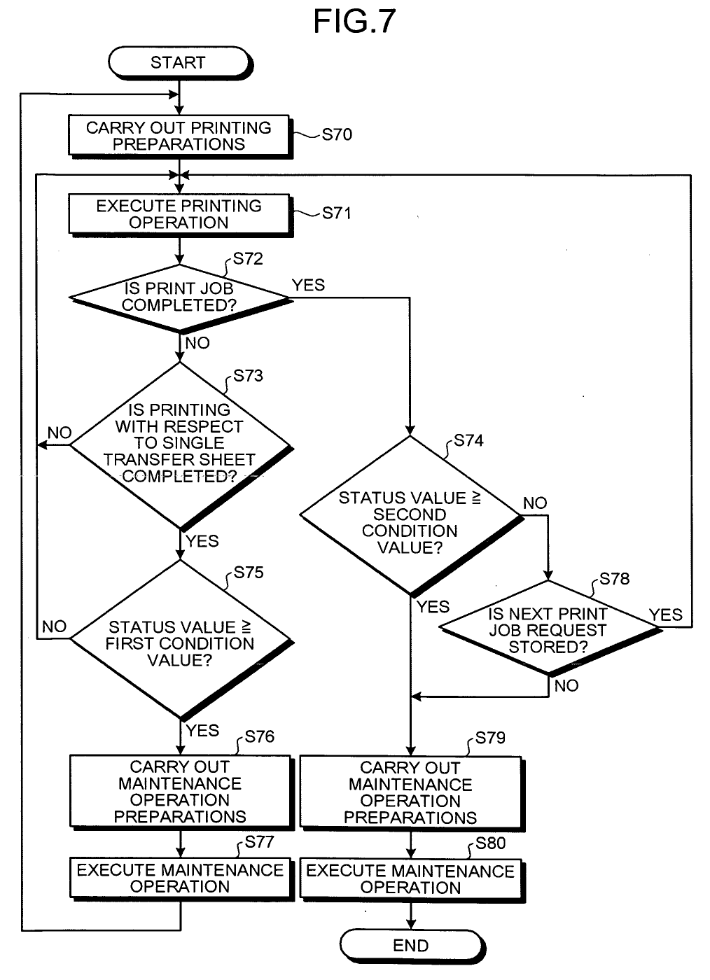

The image forming apparatus that includes the line-type inkjet printer according to a second embodiment is explained with reference to FIG. 7. In the present embodiment, the printer is explained as one example of the image forming apparatus. The image forming apparatus that includes the line-type inkjet printer according to the second embodiment differs from the image forming apparatus that includes the line-type inkjet printer according to the first embodiment only with respect to the determining unit. Constituent elements, which are indicated by similar names and reference numerals as in the first embodiment, include a similar structure and functions as in the first embodiment, unless otherwise specified.

FIG. 7 is a flowchart for explaining operations performed by the controller 138 according to the second embodiment. Similarly as in the first embodiment, the inkjet unit 136 is arranged at the maintenance operation position that is considered as the initial status.

Upon storing the print job request in the print-job request receiving unit 138a, the print executing unit 138b carries out print preparations. To be specific, the print executing unit 138b executes the restoring operations (Step S70).

When the transfer sheet is not conveyed up to the print start position, the print executing unit 138b controls the pickup roller 112, the sheet feed rollers 131, and the conveying unit 133 and moves the transfer sheet up to the print start position. Upon moving the transfer sheet up to the print start position, the print executing unit 138b causes the inkjet unit 136 to execute the printing operation for the first line of the print job (Step S71).

Upon the print executing unit 138b completing printing of the one line portion, the determining unit 138c determines whether the print job is completed (Step S72). If the print job is not completed (No at Step S72), the determining unit 138c determines whether printing with respect to the single transfer sheet is completed (Step S73). If the print job is completed (Yes at Step S72), the determining unit 138c compares the status value and the second condition value (Step S74).

In the present embodiment, the status value, the first condition value, and the second condition value are defined similarly as in the first embodiment.

If printing with respect to the single transfer sheet is not completed (No at Step S73), the printing operation is executed for the next one line portion in the same print job (Step S71). If printing with respect to the single transfer sheet is completed (Yes at Step S73), the determining unit 138c compares the status value and the first condition value (Step S75).

Upon comparing the status value and the first condition value, if the status value is less than the first condition value (No at Step S75), the printing operation is executed for the next one line portion in the same print job (Step S71). If the status value is greater than or equal to the first condition value (Yes at Step S75), preparations of the maintenance operation for the ink-heads 136a to 136d are carried out (Step S76). If the preparations of the maintenance operation, in other words, the retreating operation of the inkjet unit 136 is completed, the maintenance operation is executed with respect to the ink-heads 136a to 136d (Step S77). Upon completing the maintenance operation, the print executing unit 138b carries out printing preparations for the next one line portion in the same print job that is to be printed (Step S70).

Upon comparing the status value and the second condition value, if the status value is less than the second condition value (No at Step S74), the determining unit 138c determines whether the next print job request is stored in the print-job request receiving unit 138a (Step S78). If the next print job request is stored (Yes at Step S78), the print executing unit 138b causes the inkjet unit 136 to execute the printing operation for the first line of the print job (Step S71). Similarly as in the first embodiment, when the next print job request is issued when the inkjet unit 136 is arranged at the printing operation position, without carrying out new printing preparations, the printing operation is immediately executed. Due to this, deterioration of printing efficiency is avoided.

If the next print job request is not stored in the print-job request receiving unit 138a (No at Step S78), the preparations of the maintenance operation for the ink-heads 136a to 136d are carried out (Step S79). Upon completing the retreating operation, of the inkjet unit 136, accompanied by the preparations of the maintenance operation, the maintenance operation is executed with respect to the ink-heads 136a to 136d (Step S80). Upon completing the maintenance operation, the inkjet unit 136 waits at the maintenance operation position until the new print job request is received by the print-job request receiving unit 138a. During the waiting period, the maintenance operation can be executed at regular intervals.

Upon comparing the status value and the second condition value, if the status value is greater than or equal to the second condition value (Yes at Step S74), the maintenance executing unit 138d carries out preparations of the maintenance operation (Step S79) and executes the maintenance operation (Step S80). Upon completing the maintenance operation, the inkjet unit 136 waits at the maintenance operation position until the print-job request receiving unit 138a receives the new print job request. During the waiting period, the maintenance operation can be executed at regular intervals.

A reason for setting the two condition values such as the first condition value and the second condition value and the relation between the first condition value and the second condition value is similar to the reason and the relation explained in the first embodiment. Thus, the explanation of the reason and the relation is omitted. The determining unit according to the present embodiment differs from the determining unit 138c according to the first embodiment. Upon the determining unit 138c determining that the print job is not completed (No at Step S72), whether printing with respect to the single transfer sheet is completed is determined (Step S73). In other words, when the print job is not completed, the status value and the first condition value are not compared for each printing operation of the one line portion. The status value and the first condition value are compared only when the printing with respect to the single transfer sheet is completed. Due to this, the execution timing of the maintenance operation of the inkjet unit 136 can be more rapidly determined.

The execution timing of the maintenance operation is explained by a concrete example. For example, when the print job is executed with respect to a portion of two transfer sheets, the status value is assumed as the number of printing lines after maintenance is executed, the total number of lines on the first transfer sheet are assumed as 1000 lines, and the total number of lines on the second transfer sheet are assumed as 1400 lines. The first condition value is assumed as 900 lines and the second condition value is assumed as 350 lines. The total number of lines upon completing the print job are 2400 lines that are obtained by adding the total number of lines on the first transfer sheet and the total number of lines on the second transfer sheet. The number of printing lines, in other words, the status value is reset to zero immediately after the maintenance operation is executed. Upon receiving the print job request, the controller 138 moves the inkjet unit 136 up to the printing operation position and executes the printing operation with respect to a first line on the first transfer sheet. If the number of lines printed on the transfer sheet is less than or equal to 999, because the print job is not completed and the image formation is also not completed with respect to the first transfer sheet, the printing operation is repeated up to the 999^{th} line. Upon printing the 1000^{th} line, the image formation is also completed with respect to the first transfer sheet and the status value and the first condition value are compared. Because the status value is less than the first condition value, a first line on the second transfer sheet is printed. The status value corresponding to the first line on the second transfer sheet is 1001 lines. During the printing of the first line on the second transfer sheet, although the print job is not completed, the image formation with respect to the first transfer sheet is completed. Thus, the status value that is 1001 lines and the first condition value that is 900 lines are compared. Upon comparing the status value and the first condition value, because it is determined that the status value is greater than or equal to the first condition value, the preparations of the maintenance operation are carried out and the maintenance operation is executed. The status value is again reset to zero immediately after the maintenance operation is executed. During the printing from the second line up to the 1399-th line on the second transfer sheet, because the print job is not completed and the status value is also less than the first condition value, the printing operation with respect to the second line up to the 1399-th line is repeated. When the 1400-th line is printed, the print job is completed. Thus, the status value that is 400 lines and the second condition value that is 350 lines at the time of completion of the print job are compared and because the status value is greater than or equal to the second condition value, the maintenance operation is executed.

In another example that is explained below, the second condition value is 500 lines and other conditions are the same as those in the example mentioned earlier. The status value that is 400 lines is compared with the second condition value that is 500 lines. However, because the status value is less than the second condition value, whether the next print job request exists is confirmed. If the next print job request exists, the printing operation is executed and if the next print job request does not exist, the maintenance operation is executed.

In the concrete example explained with respect to the execution timing of the maintenance operation, although the number of printing lines after the maintenance operation is executed is explained as the status value, similarly as in the first embodiment, the continuous usage time of the inkjet unit 136 after the maintenance of the inkjet unit 136 is completed can be used as the status value. Furthermore, the image forming frequency after the maintenance of the inkjet unit 136 is completed can be used as the status value. In other words, any status value can be used if the maintenance operation can be executed after every predetermined time period or for each predetermined printing line.

According to the present embodiment, effects similar to the effects in the first embodiment can be obtained. Furthermore, a maintenance operation execution timing frequency can be reduced due to the determining unit and printing can be accelerated. Due to this, the usability of the image forming apparatus including the line-type inkjet printer can be further enhanced.

According to an embodiment of the present invention, a conveying unit conveys a transfer sheet in a nearly vertical direction. A line-type inkjet unit discharges ink on an entire area in a width direction of the transfer sheet that is conveyed by the conveying unit from a direction nearly perpendicular to the transfer sheet and forms an image on the transfer sheet. Due to this, a line-type inkjet printer including the conveying unit and the line-type inkjet unit can be made compact. Thus, by including the line-type inkjet printer, sheet feed trays, a sheet feeding unit, a sheet receiving tray, and a sheet discharging unit in an image forming apparatus, a compact image forming apparatus can be formed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a line-type inkjet printer that includes
a conveying unit that conveys a transfer sheet in a nearly vertical direction; and
a line-type inkjet unit that discharges, from a direction perpendicular to the transfer sheet, ink on an entire area in a width direction of the transfer sheet that is being conveyed by the conveying unit to print an image on the transfer sheet thereby producing an image-printed transfer sheet;
a sheet feed tray that houses blank transfer sheets;
a sheet feeding unit that feeds a blank transfer sheets from the sheet feed tray to the conveying unit;
a sheet discharging unit that discharges the image-printed transfer sheet; and
a sheet receiving tray that receives the image-printed transfer sheet discharged by the sheet discharging unit,
wherein
the sheet feed tray houses the blank transfer sheets substantially horizontally and the sheet feed tray is arranged at a position that is substantially vertically below the inkjet unit,
the sheet receiving tray houses the image-printed transfer sheets substantially horizontally and the sheet receiving tray is arranged at a position that is substantially vertically above the inkjet unit, and
the sheet discharging unit guides the image-printed transfer sheet to the sheet receiving tray by aligning a non-image forming surface of the image-printed transfer sheet with the sheet discharging unit.

2. The image forming apparatus according to claim 1, wherein the conveying unit conveys the transfer sheet by adsorption.

3. The image forming apparatus according to claim 2, wherein the conveying unit conveys the transfer sheet by electrostatic adsorption.

4. The image forming apparatus according to claim 2, wherein the conveying unit includes
a conveying belt having a plurality of holes and having a carrying surface that carries the transfer sheet and a back surface of the carrying surface; and
a negative pressure applying unit that applies a negative pressure from the back surface when the carrying surface is carrying the transfer sheet so that the transfer sheet is adsorbed to a conveying surface by air pressure.

5. The image forming apparatus according to claim 1, further comprising:
a maintenance mechanism that maintains the inkjet unit; and
a controller that controls a maintenance operation performed by the maintenance mechanism when maintaining the inkjet unit.

6. The image forming apparatus according to claim 5, wherein the maintenance mechanism performs the maintenance operation after every predetermined time period or for each predetermined printing line.

7. The image forming apparatus according to claim 5, wherein
the controller includes a determining unit and a maintenance executing unit,
the determining unit monitors a parameter that indicates a usage status of the inkjet unit and determines whether a current value of the parameter is greater than or equal to a first condition value and also determines, after completing each predetermined operation, whether a current value of the parameter is greater than or equal to a second condition value, and
the maintenance executing unit executes, by discontinuing a print job, upon the current value of the parameter being greater than or equal to the first condition value and the print job being executed, maintenance of the inkjet unit, and executes, upon the current value of the parameter being greater than or equal to the second condition value, maintenance of the inkjet unit.

8. The image forming apparatus according to claim 7, wherein the determining unit determines, for each printing operation of a one line portion, during execution of the print job, whether the current value of the parameter is greater than or equal to the first condition value.

9. The image forming apparatus according to claim 7, wherein the determining unit determines, for each printing operation of a portion of a single transfer sheet, during execution of the print job, whether the current value of the parameter is greater than or equal to the first condition value.

10. The image forming apparatus according to claim 7, wherein the determining unit determines, after completing each printing operation of a portion of a single transfer sheet, whether the current value of the parameter is greater than or equal to the second condition value.

11. The image forming apparatus according to claim 7, wherein the determining unit determines, after completing each print job, whether the current value of the parameter is greater than or equal to the second condition value.

12. The image forming apparatus according to claim 8, wherein the parameter is any of
a continuous usage time period or a lapsed time period of an inkjet unit after maintenance of the inkjet unit is completed,
number of printing lines after maintenance of the inkjet unit is completed, and
number of printed images lines after maintenance of the inkjet unit is completed.

13. The image forming apparatus according to claim 9, wherein the parameter is any of
a continuous usage time period or a lapsed time period of an inkjet unit after maintenance of the inkjet unit is completed,
number of printing lines after maintenance of the inkjet unit is completed, and
number of printed images lines after maintenance of the inkjet unit is completed.

14. The image forming apparatus according to claim 10, wherein the parameter is any of
a continuous usage time period or a lapsed time period of an inkjet unit after maintenance of the inkjet unit is completed,
number of printing lines after maintenance of the inkjet unit is completed, and
number of printed images lines after maintenance of the inkjet unit is completed.

15. The image forming apparatus according to claim 11, wherein the parameter is any of
a continuous usage time period or a lapsed time period of an inkjet unit after maintenance of the inkjet unit is completed,
number of printing lines after maintenance of the inkjet unit is completed, and
number of printed images lines after maintenance of the inkjet unit is completed.

16. The image forming apparatus according to claim 5, wherein the controller exercises control to move the inkjet unit between a printing operation position for forming an image on the transfer sheet and a maintenance operation position near the maintenance mechanism.

17. The image forming apparatus according to claim 16, wherein
the inkjet unit is rotatable around a rotation axis, and
the controller rotates, at the time of moving the inkjet unit between the printing operation position and the maintenance operation position, the inkjet unit at least around the rotation axis.

18. The image forming apparatus according to claim 5, wherein the maintenance mechanism is arranged at a position that is substantially vertically below the inkjet unit.

19. The image forming apparatus according to claim 16, wherein the controller causes the inkjet unit to move, by using a combination of rotation around the rotation axis and horizontal movement, between the printing operation position and the maintenance operation position.

20. The image forming apparatus according to claim 18, wherein the controller causes the inkjet unit to move, by using a combination of rotation around the rotation axis and horizontal movement, between the printing operation position and the maintenance operation position.
